(19) United States
(12) Patent Application Publication
(10) Pub. No.: US 2016/0158819 A1
(43) Pub. Date: Jun. 9, 2016

(54) Compact Pneumatic Auto Body Hammer with Fine Control of Impact Force

(71) Applicant: Paul E. JOHNSON, Springfield, OR (US)

(72) Inventor: Paul E. JOHNSON, Springfield, OR (US)

(21) Appl. No.: 14/559,406

(22) Filed: Dec. 3, 2014

(51) Int. Cl. B21D 1/12; B25D 9/06; B25D 9/16; B21D 1/06

(52) U.S. Cl. CPC B21D 1/12; B21D 1/065; B25D 9/06; B25D 9/16

(57) ABSTRACT

A hand-held pneumatic impact tool for striking and planishing metal panels includes a monostable, reciprocating impact mechanism in a small form factor, with an air pressure regulator to control striking force and interchangeable toolheads to apply the force as necessary to repair dented or crumpled vehicle bodies.

### CONTINUITY AND CLAIM OF PRIORITY

This is an original U.S. patent application.

### FIELD

The invention relates to auto body repair. More specifically, the invention relates to pneumatically-operated impact tools for repairing dented body panels.

### BACKGROUND

Vehicle body panels were once formed by hand, with craftsmen beating or planishing metal sheets over solid forms to create desired surfaces. Manufacturing techniques have advanced significantly over the decades, and most contemporary metal body panels are formed by stamping, hydroforming or even higher-tech processes.

However, vehicles often become involved in mishaps that result in damage to these carefully-formed, complexly-curved panels. This damage cannot generally be repaired by removing the panel and re-pressing it in the original forms—the panel will already have been finished with paint or other coatings, and may have been permanently fixed to the vehicle (e.g., by adhesive or welding). Thus, in-place and by-hand repair is usually the most economical, and often the only way to restore a creased, dented or crumpled panel.

Tools to repair body panels typically comprise mechanisms to apply sharp impacts to a panel through a shaped tool head. Tools are often pneumatically operated, although electrical and manual alternatives are also in use. When the tools are too large or unwieldy to position behind a damaged panel, the repair person must often work from the outside of the dent, for example by welding a stud to the panel and then using a tool such as a slide hammer to create tension (pulling) impacts rather than the more common compression (pushing) impacts. Repairs from the outside of a dent thus require additional work to remove the stud and re-finish the panel.

Small, easily manipulated impact tools are known in the art (for example, U.S. Pat. No. 3,813,993 by Smith describes a hand-held pneumatic impact tool that is small enough to operate in confined spaces behind dented panels). Similarly, proposals to adapt impact tools for other applications to use in body repair have been made. For example, U.S. Patent Application Publication No. 2007/0057009 by Thorne and Preacher describes planishing attachments for a “palm nailer”—a small pneumatic device designed to drive nails in places where a hammer cannot easily be used.

The present applicant's long experience in vehicle body repair suggests that these prior art devices are not well known, not commonly used, and have never achieved commercial success. System improvements and methods of use that can turn these known devices into practical, useful tools may be of significant value.

### SUMMARY

Embodiments of the invention are systems comprising a hand-held pneumatic hammer with an interchangeable tool head and a pneumatic pressure regulator to provide fine control of impact force.

### BRIEF DESCRIPTION OF DRAWINGS

FIG. 1 shows a planishing system according to an embodiment of the invention.

FIG. 2 shows a representative planishing tool according to an embodiment.

FIG. 3 shows a cross section of an embodiment and an assortment of toolheads.

FIG. 4 shows a representative toolhead-interchange mechanism.

FIG. 5 shows another assortment of planishing toolheads.

FIGS. 6A-6c show views of another embodiment of the invention.

FIG. 7 is a flow chart outlining a method of using the inventive planishing system.

### DETAILED DESCRIPTION

Prior-art standard pneumatic planishing hammers are too large to use in many vehicle body repair situations (for example, in repairing dents to door panels, the hammer may not fit between the exterior panel and the door's supporting structure, or the structure may prevent the application of impacts from the hammer to a part of the dent). Small prior-art hammers may fit in the space available, but they do not offer good control over the impact force, so they may over-strike the dent, causing a convex bulge in the exterior panel that must also be repaired.

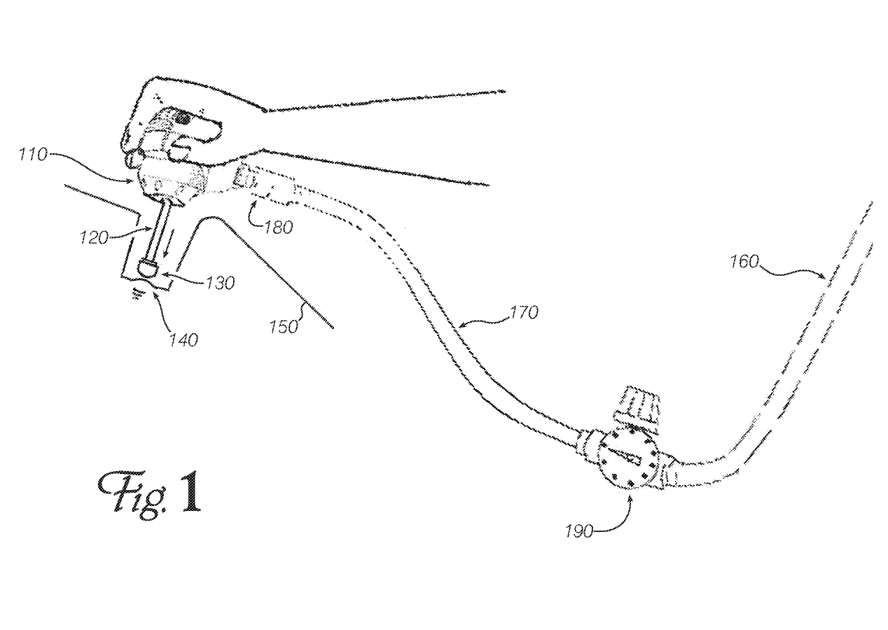

FIG. 1 shows an example system according to an embodiment being used to repair a dent in an irregularly-shaped body panel. The tool 110 is sized and shaped to fit a user's hand comfortably. An extension shaft 120 transmits impacts generated by the tool to a toolhead or anvil 130, which acts on the dent at 140 in body panel 150 (panel and dent shown in profile/cutaway). Energy to drive the tool is supplied via a high-pressure pneumatic or hydraulic line 160, 170, which connects to tool 110 via a reversible connector 180. An important part of the inventive system is pressure regulator 190, which functions as described below.

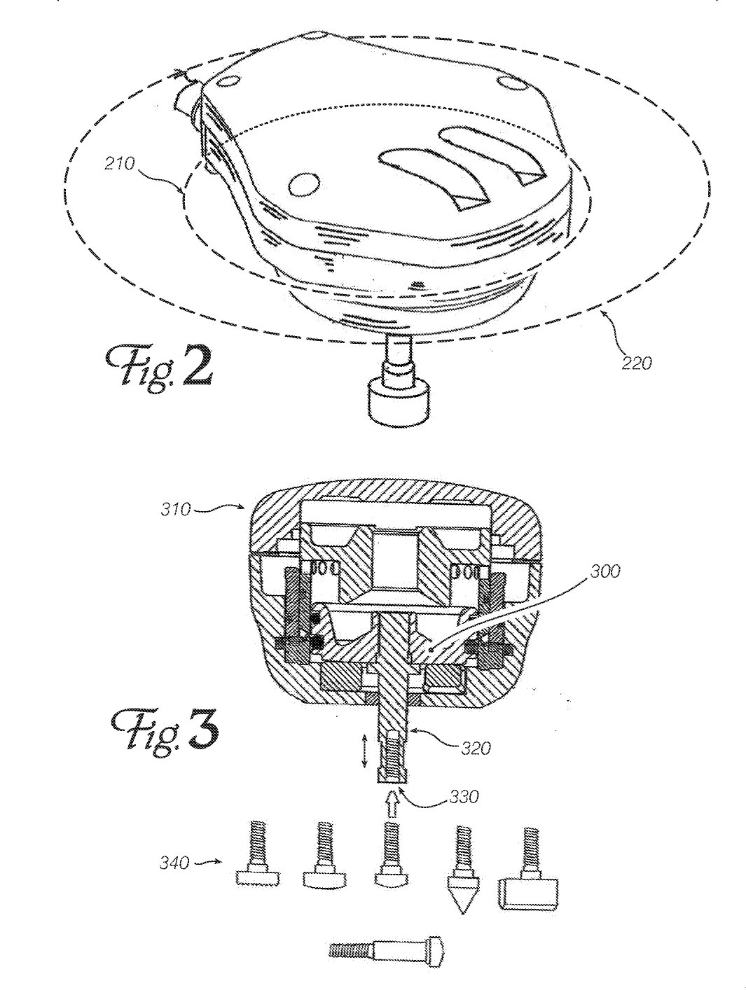

FIG. 2 shows the tool portion of an embodiment of the invention. Suitable structures are preferably as small as possible, limited by the needs to develop adequate impact force and for the user to hold, manipulate and control the tool. Most embodiments will be similar in size to a sphere with diameter between 75 mm and 120 mm (shapes are often irregular or non-spherical so that the user can rotate them to operate in constrained spaces, and to provide additional torsion resistance to the grip). Many edges are preferably rounded to reduce the chance of operator injury and to facilitate access to small, irregularly-shaped repair areas. FIG. 2 includes two size indicators: a circle of diameter 60 mm (210), which is too small to contain the tool; and a circle of diameter 150 mm (220), within which the tool fits completely. In other words, the tool overfills the smaller circle (and also a sphere of similar diameter), but lies entirely within the larger circle (and also within a sphere of similar diameter).

Internally, many embodiments use a monostable, short-stroke, pneumatically-driven piston to produce the impact action. One suitable mechanism is shown and described in substantial detail in U.S. Pat. No. 3,813,993 to Smith. The entire disclosure of that patent is incorporated by reference here. Other embodiments may use an electrically-driven solenoid to produce the impact action.

Turning to FIG. 3, and regardless of the motive power of an embodiment, the tool's “business end” will include a monostable reciprocating impact mechanism 300 in a housing 310 sized and shaped to fit comfortably and securely in the user's hand. The impact mechanism is coupled to a linearly reciprocating shaft 320 which has a receptacle 330 to accept an interchangeable toolhead or anvil. An assortment of such toolheads is shown at 340; from left to right, these are a “shrinking” head, large- and small-radius convex heads, a small-point conical head, a linear or knife-edge head, and an extended-reach convex head. Toolheads may have a threaded shank and be interchanged by loosening and tightening with a wrench, as shown in FIG. 4; or they may be held in place with a standard mechanical taper such as a Morse taper, by a spring-loaded clip or ball, by magnetic attraction, or by another conventional method.

A tool according to an embodiment is a monostable reciprocating device—that is, it does not automatically begin hammering as soon as pressurized air is applied. Instead, the toolhead assumes a fixed, stable position until the tool can be maneuvered into place. Then, a single strike or a sequence of strikes can be initiated by a trigger mechanism. In a preferred embodiment, hammering is initiated by pressing the toolhead firmly against the surface to be planished. When the user's pressing force exceeds a predetermined trigger force (set, e.g., by the locations of intake and exhaust ports in a pneumatic reciprocating mechanism and by the applied air pressure) the tool performs a striking cycle. If the user continues to press the tool against the panel with a force exceeding the trigger force, repetitive strikes will be made. Preferably, the stroke of each cycle will be between about 1 cm and 2 cm, although shorter- and longer-stroke tools may have applications in some specialty situations (e.g., operation in extremely constrained areas or on softer or stiffer malleable panels).

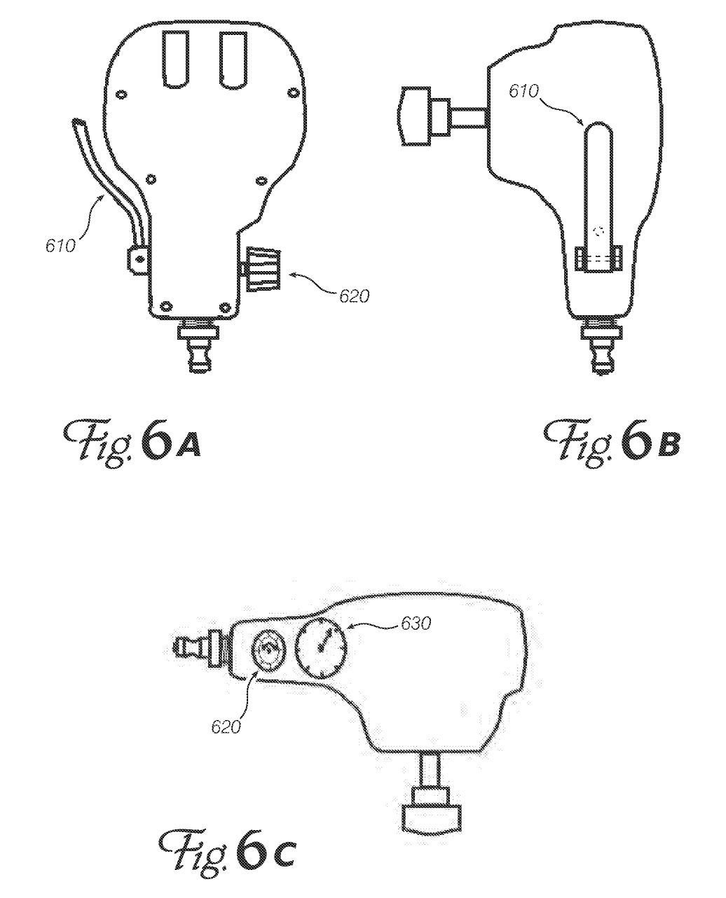

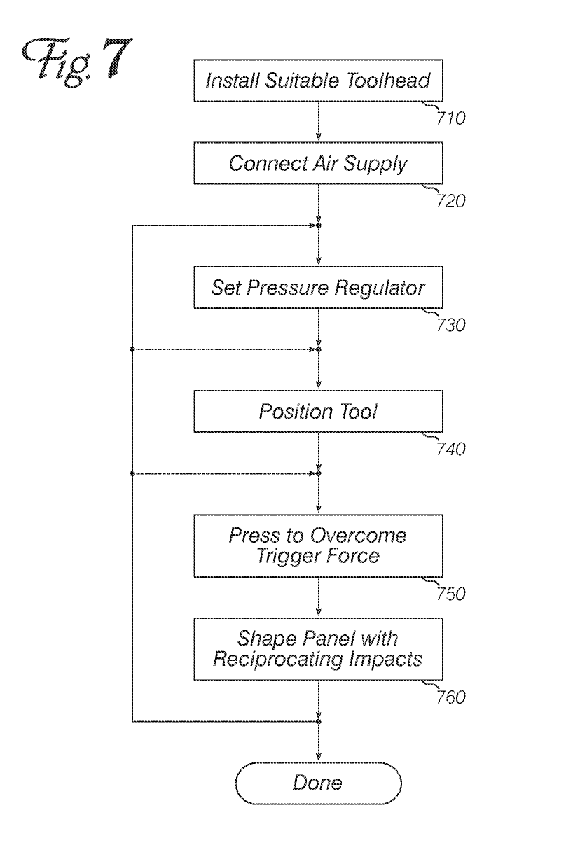

In another embodiment, a mechanical trigger (actuated, e.g., by the user's thumb) may initiate striking action. Such a mechanical trigger is shown in FIGS. 6A and 6B at 610. Thus, for example, the tool may be manipulated into position and then lever 610 is pressed. While the lever is pressed or held, the tool executes striking cycles. A trigger mechanism of this sort is also suitable for use on an electrically-actuated tool (i.e., where the striking action comes from an electrical solenoid.)

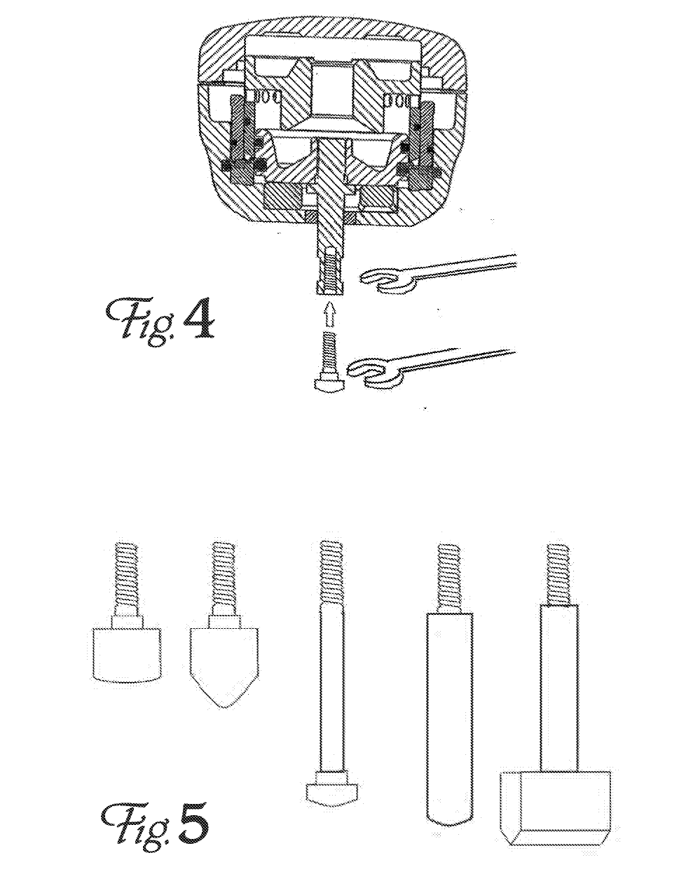

It should be noted that the striking frequency or repetition rate of a tool according to an embodiment depends partly on the reciprocating mass, and partly on the motive pressure supplied by the pneumatic connection. To alter the striking frequency and the inertia of the toolhead that can be transferred to the dented panel, an embodiment may comprise interchangeable toolheads of varying mass—from small, lightweight anvils for rapid, low-inertia hammering, to larger, heavier anvils for slower and more energetic hammering. An embodiment may provide interchangeable extension shafts of varying weight, permitting any particular anvil to be operated at faster or slower hammering rates. See, for example, the toolhead assortment shown in FIG. 5.

Varying the air pressure of the system can change the striking frequency, but it also varies the striking force. In fact, Applicant has determined that air pressure control is a critical feature of the inventive system. Without pressure control, a hand-held pneumatic hammer device cannot provide the lighter impacts necessary to finish a repair without over-hammering and out-denting the panel. Thus, an embodiment comprises a pressure regulator, which may be placed at the compressor or air storage tank; inline between the compressor and the tool, or on the body of the tool itself. (On-tool placement is shown in FIGS. 6A and 6c at 620.) In a preferred embodiment, the regulator is placed inline. Inline placement allows the user to adjust the air pressure dynamically with one hand while performing a repair with the tool held in the other hand. When placed at the compressor, the regulator may be inaccessible to the operator during a repair, and the reduced pressure may impair operation of other tools that require higher pressures. When incorporated into the tool itself, a regulator may increase the size of the tool or provide inconsistent regulation clue to vibrations from the tool's operation. The pressure regulator reduces the main-supply pressure to a lower tool-supply pressure under operator control to obtain the desired striking force.

The embodiments shown in the foregoing figures have a single air supply line and exhaust to the atmosphere. However, an embodiment provided with an air-return line may operate in a closed loop fashion. This may reduce the operational noise emitted by the tool (although the noise of hammering a panel is inevitably significant). With a closed-loop system, motive power may be provided by pressurized liquid (i.e., hydraulically) instead of by pressurized gas.

FIG. 7 outlines a method of using a tool according to an embodiment of the invention. A suitable toolhead is selected and installed (710), for example by screwing in and tightening the toolhead as shown in FIG. 4. An air supply is connected (720). Next, the operator sets the tool pressure (730) using the regulator located at the compressor, inline in the supply hose to the tool, or on the tool itself. The tool is positioned near an area to be struck (740) and the toolhead is pressed against the target area with sufficient force to activate the trigger (750). One or more impact cycles are thereby initiated, and the impact(s) are used to shape the panel (750).

The applications of the present invention have been described largely by reference to figures showing specific exemplary embodiments, with alternate implementations and operational details as discussed. However, those of skill in the art will recognize that small, hand-held pneumatic or hydraulic impact tools can also be constructed of components shaped or configured differently than herein described. Such variations and alternate configurations are understood to be captured according to the following claims.

I claim:

1. A vehicle-body impact repair tool comprising:
a monostable reciprocating impact mechanism;
a housing containing the impact mechanism;
an interchangeable toolhead receptacle coupled to the impact mechanism; and
an anvil adapted for installation in the toolhead receptacle, wherein
the housing outer periphery viewed perpendicular to a reciprocating axis of the impact mechanism overfills a 6 cm diameter circle but lies entirely within a 15 cm circle.

2. The impact repair tool of claim 1 wherein the monostable reciprocating impact mechanism is actuated by pneumatic pressure, the tool further comprising:
a pressure regulator to control a pressure of an air supply for actuating the impact mechanism.

3. The impact repair tool of claim 2 wherein the pressure regulator is incorporated within the housing containing the impact mechanism.

4. The impact repair tool of claim 2 wherein the pressure regulator is outside the housing and in fluid communication between the monostable reciprocating impact mechanism and the air supply.

5. The impact repair tool of claim 1 wherein a stroke of the monostable reciprocating mechanism is between about 0.5 cm and about 4 cm.

6. The impact repair tool of claim 1 wherein a stroke of the monostable reciprocating mechanism is between about 1 cm and about 2 cm.

7. The impact repair tool of claim 1, further comprising:
a plurality of differently-shaped anvils, each adapted for installation in the toolhead receptacle.

8. The impact repair tool of claim 7, wherein the plurality of differently-shaped anvils consists of:
a shrinking head;
a small-radius convex head;
a large-radius convex head;
a conical point head;
a knife-edge head; and
an extended-reach convex head.

9. A pneumatic body hammer tool comprising:
a monostable, pneumatically-driven reciprocating mechanism;
an anvil receptacle coupled to the reciprocating mechanism;
an anvil adapted for installation in the anvil receptacle; and
a pneumatic pressure regulator to control a pressure of an air supply for driving the reciprocating mechanism.

10. The pneumatic body hammer of claim 9, further comprising:
a trigger mechanism to initiate reciprocation of the monostable, pneumatically-driven reciprocating mechanism.

11. The pneumatic body hammer of claim 10 wherein the trigger mechanism is activated by pressing the anvil against a workpiece with a force exceeding a predetermined value.

12. The pneumatic body hammer of claim 10 wherein the trigger mechanism is a lever.

13. The pneumatic body hammer of claim 10 wherein activation of the trigger mechanism initiates a single reciprocating cycle.

14. The pneumatic body hammer of claim 10 wherein activation of the trigger mechanism initiates a plurality of reciprocating cycles.

15. An auto-body repair system comprising:
a hand-held pneumatic hammer device having an outer housing too large to fit within a 6 cm-diameter sphere but smaller than a 15 cm-diameter sphere;
an air pressure regulator to reduce a main-supply air pressure to a tool-supply air pressure; and
a plurality of interchangeable toolheads, each toolhead adapted to be coupled to the hand-held pneumatic hammer device.

16. The auto-body repair system of claim 15 wherein a first toolhead of the plurality of interchangeable toolheads has a mass different from a second toolhead of the plurality of interchangeable toolheads.

17. The auto-body repair system of claim 15, further comprising:
a plurality of interchangeable extension shafts of varying mass, where each extension shaft of the plurality of interchangeable extension shafts is adapted to be coupled to the toolhead and the hand-held pneumatic hammer device, and wherein
a first striking rate of the system configured with a first extension shaft is different from a second striking rate of the system configured with a second extension shaft.

18. The auto-body repair system of claim 15 wherein the pressure regulator is integrated within the outer housing of the hand-held pneumatic hammer device.

19. The auto-body repair system of claim 15 wherein the pressure regulator is located separately from the outer housing of the hand-held pneumatic hammer device and between said device and an air supply.
